(19) United States
(12) Patent Application Publication
(10) Pub. No.: US 2008/0112639 A1
(43) Pub. Date: May 15, 2008

(54) Method and apparatus for removing noise in dark area of image

(75) Inventors: Kyoung Joong Min, Seoul (KR); Won Tae Choi, Yongin (KR); Tae Eung Kim, Yongin (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/984,211

(22) Filed: Nov. 14, 2007

(30) Foreign Application Priority Data
Nov. 14, 2006 (KR) 10-2006-112328

(51) Int. Cl. G06K 9/40

(52) U.S. Cl. 382/264

(57) ABSTRACT

A method and apparatus for removing noise in a dark area of an image are provided. An edge magnitude in an N×N window image including a plurality of pixels is calculated. It is determined whether an edge area is present in the window image on the basis of the edge magnitude. A mean value of brightness of the window image is calculated when the edge area is not present. It is determined whether the window image corresponds to a bright area or a dark area on the basis of the mean value. The window image is determined as the bright area when the mean value is higher than a preset brightness reference value, and low-pass filtering is performed on the window image. The window image is determined as the dark area when the mean value does not exceed the reference value, and minimum filtering is performed on the window image.

### CROSS-REFERENCE TO RELATED APPLICATIONS

This application claims the priority of Korean Patent Application No. 2006-112328, filed on Nov. 14, 2006, in the Korean Intellectual Property Office, the disclosure of which is incorporated herein by reference.

### BACKGROUND OF THE INVENTION

1. Field of the Invention

The present invention relates to a method and apparatus for removing noise in a dark area of an image, which are applied to a digital camera device, and more particularly, to a method and apparatus for removing noise in a dark area of an image, which are configured to improve a contrast ratio and color saturation of the image by removing noise in a dark area of the image.

2. Description of the Related Art

In general, when a digital camera captures an image in a bright place, an exposure time of the camera is short, and thus relatively small noise occurs in a dark area of the captured image. However, since the entire exposure time lengthens when photographing is made in a dark place or at night, more noise occurs in a dark area of a captured image.

One of methods for removing the noise is using a low pass filter (LPF) such as a mean filter or a median filter.

However, since the low-pass filter uses a mean or median value of neighboring pixels, the low pass filter cannot effectively operate in the case of high-level noise.

FIG. 1 is a block diagram of a general digital camera.

The general digital camera illustrated in FIG. 1 includes an image sensor unit 10 including an image sensor and capturing an image of an object, and an image signal process unit 20 processing an image signal from the image sensor unit 10.

To remove noise during a conventional image processing process, Y, Cb, and Cr or Y, U and V compression data after image interpolation is commonly used.

For example, a low-pass filter is applied to an entire image, using 3×3 window image data. The low-pass filter removes noise by substituting a current pixel value with a mean value of neighboring pixels of the 3×3 window image data.

However, the conventional noise removing method has limitations because when the low-pass filtering is performed on an entire window image having a specific size to remove noise, edge information (high-frequency component) of the image is undesirably removed together with the noise, resulting in serious deterioration of sharpness of the image.

To maintain the sharpness of an image, a method is widely used, in which an edge area is detected first, using, for example, a 3×3 or 5×5 window image, and then noise is removed only from a non-edge area, not from the edge area. This image processing method will now be described with reference to FIG. 2.

FIG. 2 is a flow chart illustrating a conventional image processing process.

Referring to FIG. 2, in operation S10, preprocessing including dark noise rejection, dead pixel correction, and lens shading correction is performed on an image of the image sensor unit. In operation S20, image signals sequentially input in series through the preprocessing are sequentially buffered in a plurality of line, and are converted into a window image of a predetermined size, for example, a 3×3 window image. In operation S30, the 3×3 window image is interpolated, and an interpolated image signal is output. In operation S40, the interpolated RGB image signal is converted into a YCbCr image signal. In operation S50, an edge area and a non-edge area are distinguished from each other in the converted YCbCr image signal, and noise of the non-edge area is removed by using a low pass filter (LPF).

However, this conventional image processing method has limitations because noise may affect adjacent signals since the noise is removed after the image interpolation.

Also, in the case of high-level noise, the noise may propagate to neighboring pixels due to the image interpolation and signal conversion, thereby seriously affecting neighboring signals.

Furthermore, the low-pass filter using a mean or median value may effectively operate in a bright area of an image, but does not remove noise in a dark area of the image.

### SUMMARY OF THE INVENTION

An aspect of the present invention provides a method and apparatus for removing noise in a dark area of an image, which are configured to improve a contrast ratio and color saturation of an image by removing noise of a dark area of the image.

According to an aspect of the present invention, there is provided a method for removing noise in a dark area of an image including: calculating an edge magnitude in an N×N window image including a plurality of pixels; determining whether an edge area is present in the window image on the basis of the edge magnitude; calculating a mean value of brightness of the window image when the edge area is not present; determining whether the window image corresponds to a bright area or a dark area on the basis of the mean value of brightness; determining the window image as the bright area when the mean value of brightness is higher than a preset brightness reference value, and performing low-pass filtering on the window image; and determining the window image as the dark area when the mean value of brightness does not exceed the brightness reference value, and performing minimum filtering on the window image.

The performing of the minimum filtering may include substituting each pixel value of the window image with a substitution value determined differently depending on a darkness degree based on the mean value of brightness of the dark area of the window image.

The performing of the minimum filtering may include: comparing the mean value of brightness of the dark area of the window image with a first preset black reference value; calculating a minimum pixel value of the window image when the mean value of brightness is lower than the first preset black reference value, and substituting each pixel value of the window image with the minimum pixel value; and calculating a differential substitution value that is higher than the first preset black reference value by a preset value when the mean value of brightness is not lower than the first black reference value, and substituting each pixel value of the window image with the differential substitution value.

The differential substitution value may be a mean value of a first minimum pixel value that is the lowest among a plurality of pixel values of the window image and a second minimum pixel value that is the second lowest among the plurality of pixel values of the window image.

The minimum filtering may be performed before image interpolation during a processing process of the window image.

The minimum filtering may be performed after image interpolation during a processing process of the window image.

The N×N window image may be a 5×5 window image.

According to another aspect of the present invention, there is provided an apparatus for removing noise in a dark area of an image including: an edge determining unit determining whether an edge area is present in an N×N window image including a plurality of pixels; a brightness determining unit calculating a mean value of brightness of the window image, and determining whether the window image corresponds to a bright area or a dark area on the basis of the mean value of brightness; a first image delay unit delaying the window image by a preset time; a noise filtering unit performing low-pass filtering and minimum filtering on the window image output from the first image delay unit; a second image delay unit delaying the window image output from the first image delay unit by a preset time; and a multiplexer selecting one of a signal output from the noise filtering unit and a signal output from the second image delay unit on the basis of edge information output from the edge determining unit, and selecting one of a low-pass filtered signal and a minimum-filtered signal among signals output from the noise filtering unit on the basis of image brightness information output from the brightness determining unit.

The noise filtering unit may include: a low-pass filtering unit performing low-pass filtering on the window image output from the first image delay unit; a minimum-value filtering unit performing minimum-value pass filtering on the window image output from the first image delay unit; and a differential-lower-value filtering unit performing differential-lower-value pass filtering on the window image output from the first image delay unit.

When the edge area is present in the window image on the basis of the edge information output from the edge determining unit, the multiplexer may select a signal output from the second image delay unit, and when the edge area is not present in the window image, the multiplexer may select a signal output from the low-pass filtering unit if the image brightness information of the brightness determining unit indicates the bright area, and the multiplexer may select a signal output from the minimum-value filtering unit or a signal output from the differential-lower-value filtering unit on the basis of darkness information if the image brightness information output from the brightness determining unit indicates the dark area.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a general digital camera device;

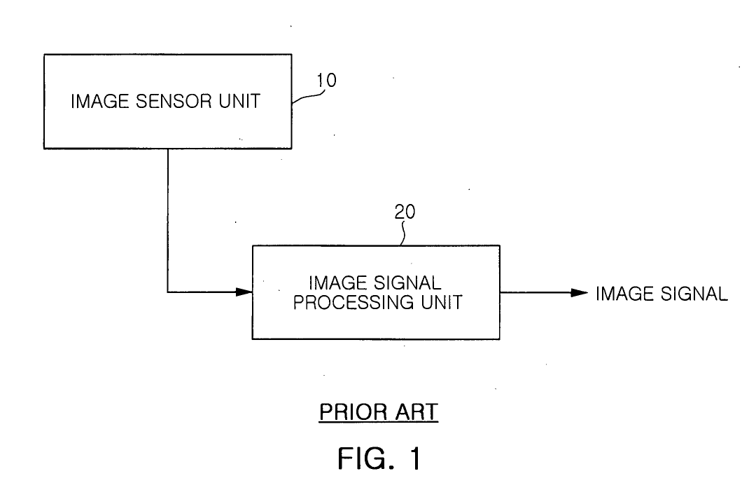

FIG. 2 is a flowchart illustrating a conventional image processing process;

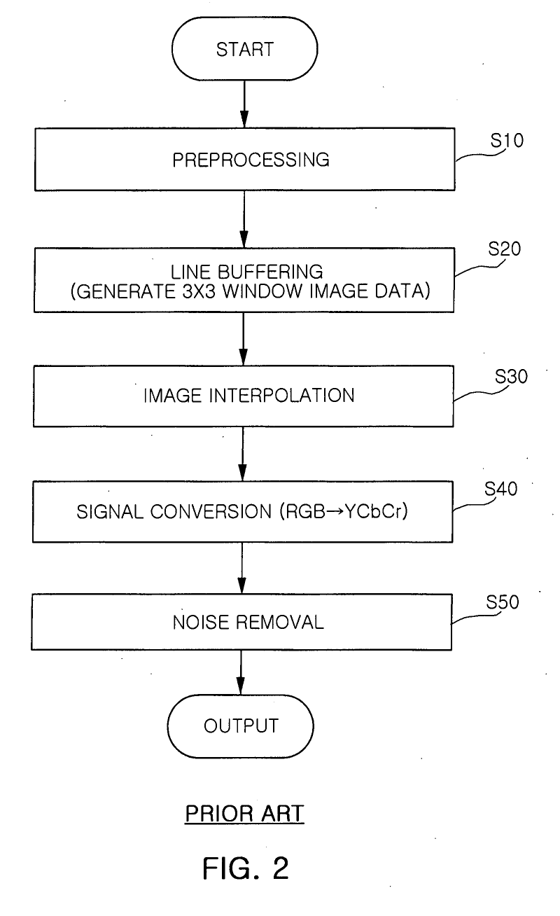

FIG. 3 is a flowchart illustrating a method for removing noise in a dark area of an image according to an embodiment of the present invention;

FIGS. 4A and 4B illustrate 5×5 window image patterns, respectively;

FIG. 5 illustrates an edge area and a non-edge area of an image;

FIG. 6 is a flowchart illustrating minimum filtering in a dark area of FIG. 3;

FIG. 7 is a block diagram of an apparatus for removing noise in a dark area of an image according to an embodiment of the present invention; and

FIG. 8 is a graph showing pixel values of an image before and after correction according to the present invention.

### DETAILED DESCRIPTION OF THE PREFERRED EMBODIMENT

Exemplary embodiments of the present invention will now be described in detail with reference to the accompanying drawings.

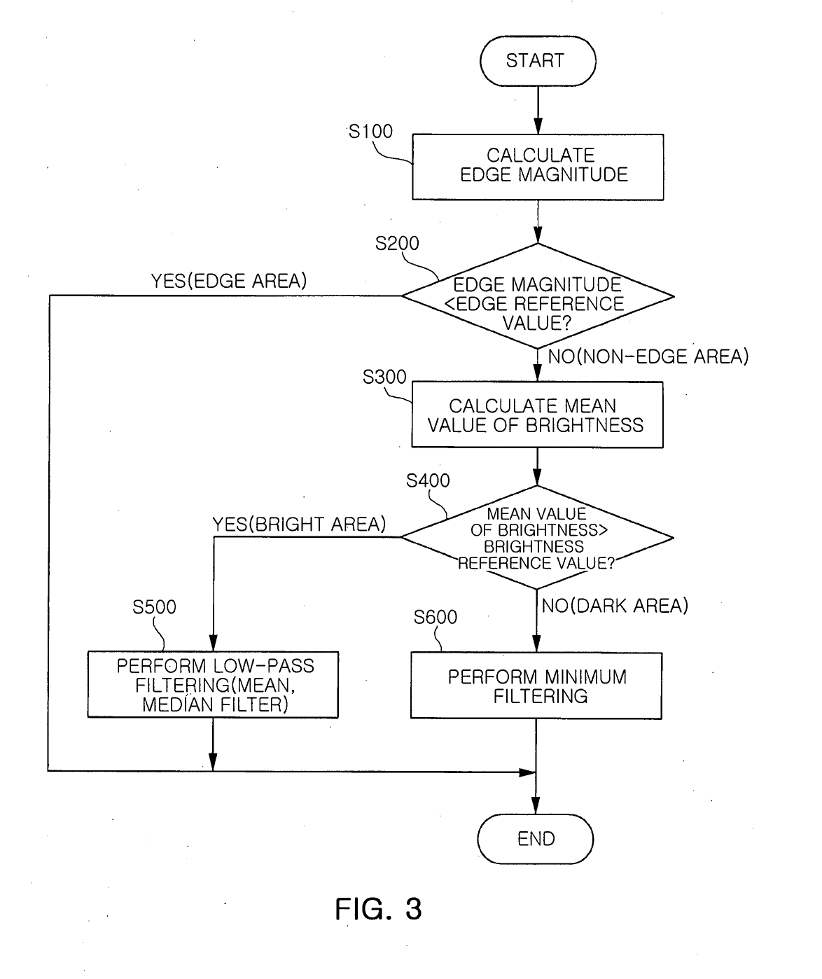

FIG. 3 is a flowchart of a method for removing noise in a dark area of an image according to an embodiment of the present invention.

Referring to FIG. 3, in operation S100, an edge magnitude in an N×N window image including a plurality of pixels is calculated. In operation S200, it is determined whether an edge area is present in the window image on the basis of the edge magnitude. In operation S300, when the edge area does not exist, a mean value of brightness of the window image is calculated. In operation S400, it is determined whether the window image corresponds to a bright area or a dark area on the basis of the mean value of brightness. In operation S500, when the mean value of brightness is higher than a preset brightness reference value, it is determined that the window image corresponds to the bright area, and low-pass filtering is performed on the window image. In operation S600, when the mean value of brightness does not exceed the brightness reference value, it is determined that the window image corresponds to the dark area, and minimum filter is performed on the window image.

In operation S600, the minimum filtering is performed such that each pixel value of the window image is substituted with a substitution value determined differently depending on a darkness degree based on the mean value of brightness of a dark area of the window image.

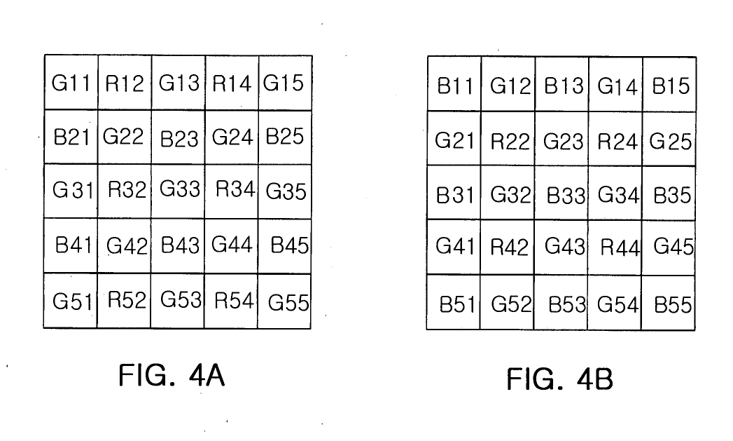

The N×N window image may correspond to a 5×5 window image, and this will now be described with reference to FIGS. 4A and 4B.

FIGS. 4A and 4B illustrate 5×5 window image patterns, respectively. In FIG. 4A, a green pixel G is placed at the center of the 5×5 window image pattern, and in FIG. 4B, a blue pixel B is placed at the center of the 5×5 window image pattern.

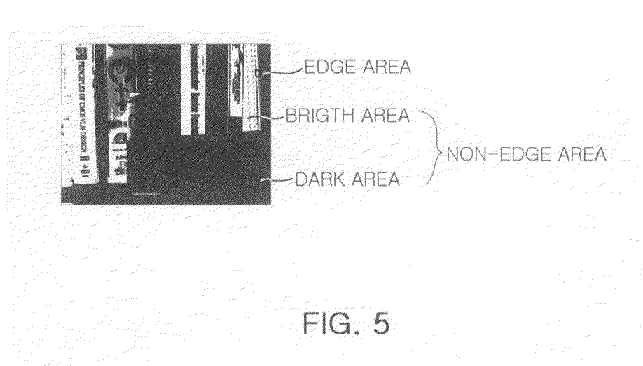

FIG. 5 illustrates an edge area and a non-edge area of an image. In FIG. 5, areas that may be included in a window image are illustrated, and the window image may include an edge area and a non-edge area, and the non-edge area may include a bright area and a dark area.

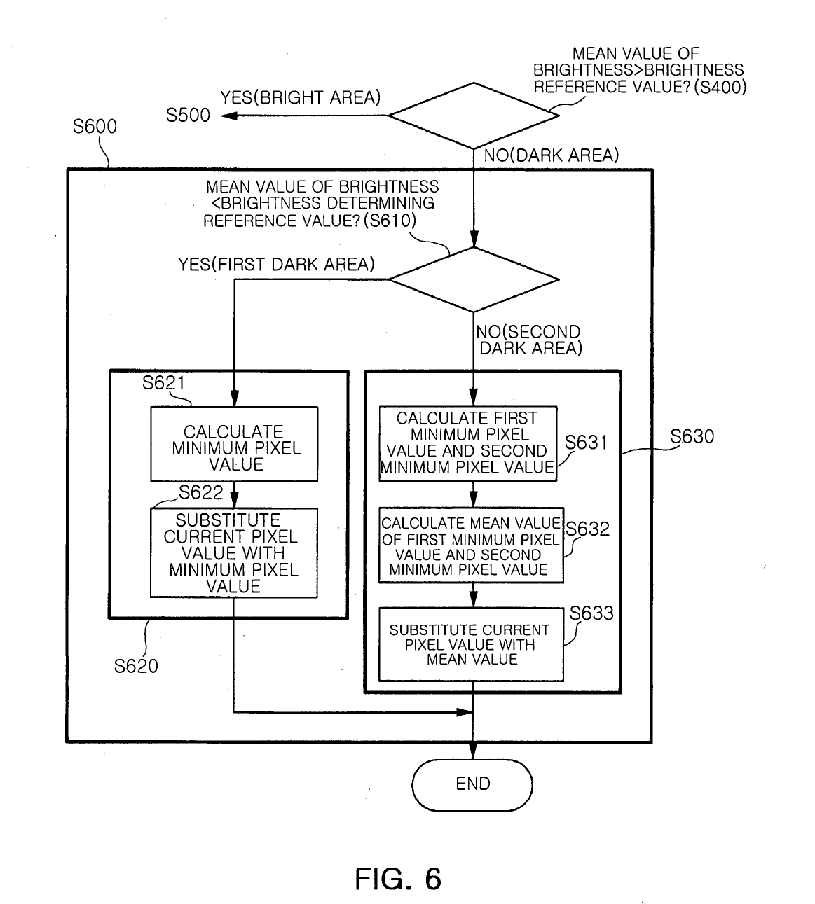

FIG. 6 is a flowchart of minimum filtering in a dark area of FIG. 3.

The minimum filtering will now be described with reference t FIG. 6. In operation S610, the mean value of brightness of the dark area of the window image is compared with a first preset black reference value. In operation S620, when the mean value of brightness is lower than the first preset black reference value, a minimum pixel value of the window image is calculated in operation S621, and each pixel value of the window image is substituted with the minimum pixel value in S622. In operation S630, when the mean value of the brightness is not lower than the first preset black reference value, a differential substitution value which is higher than the first black reference value by a preset value is calculated, and each pixel value of the window image is substituted with the differential substitution value in operation S633.

In operations S631 and S632, the differential substitution value may correspond to a mean value of a first minimum pixel value that is the smallest among a plurality of pixel values of the window image, and a second minimum pixel value that is the second smallest among the plurality of pixel values of the window image.

The minimum filtering in operation of S600 may be performed before image interpolation of the window-image processing process.

The minimum filtering in operation of S600 may be performed after the image interpolation of the window-image processing process.

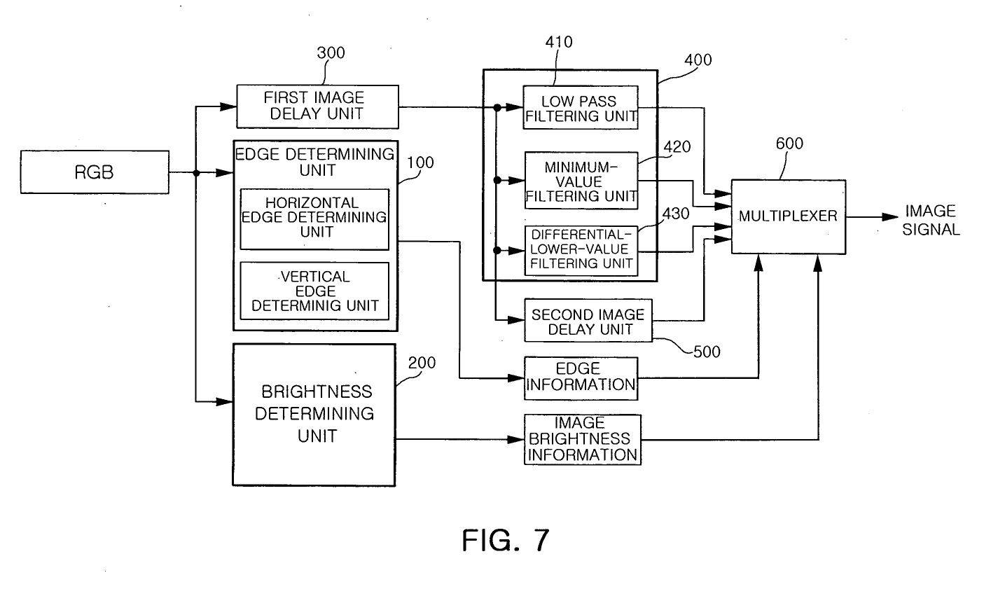

FIG. 7 is an apparatus for removing noise in a dark area of an image according to an embodiment of the present invention.

Referring to FIG. 7, the apparatus for removing noise in a dark area of an image according to an embodiment of the present invention includes an edge determining unit 100, a brightness determining 200, a first image delay unit 300, a noise filtering unit 400, a second image delay unit 500, and a multiplexer 600. The edge determining unit 100 determines whether an edge area is present in an N×N window image including a plurality of pixels. The brightness determining unit 200 calculates a mean value of brightness of the window image, and determines whether the window image corresponds to a bright area or a dark area on the basis of the mean value of brightness. The first image delay unit 300 delays the window image by a preset time. The noise filtering unit 400 performs low-pass filtering and minimum filtering on the window image output from the first image delay unit 300. The second image delay unit 500 delays the window image output from the first image delay unit 300 by a preset time. The multiplexer 600 selects one of a signal output from the noise filtering unit 400 and a signal output from the second image delay unit 500 on the basis of edge information output from the edge determining unit 100. Also, the multiplexer 600 selects one of a low-pass filtered signal and a minimum-filtered signal among signals output from the noise filtering unit 400 on the basis of image brightness information output from the brightness determining unit 200.

The noise filtering unit 400 includes a low-pass filtering unit 410, a minimum-value filtering unit 420, and a differential-lower-value filtering unit 430. The low-pass filtering unit 410 performs low-pass filtering on the window image output from the first image delay unit 300. The minimum-value filtering unit 420 performs minimum-value pass filtering on the window image output from the first image delay unit 300. The differential-lower-value filtering unit 430 performs differential-lower-value pass filtering on the window image output from the first image delay unit 300.

When an edge area is present in the window image on the basis of the edge information output from the edge determining unit 100, the multiplexer 600 selects a signal output from the second image delay unit 500. When the edge area does not exist and the window image corresponds to a bright area on the basis of the image brightness information output from the brightness determining unit 200, the multiplexer 600 selects a signal output from the low-pass filtering unit 410. In contrast, when the edge area does not exist and the window image corresponds to a dark area on the basis of the image brightness information output from the brightness determining unit 200, the multiplexer 600 selects a signal output from the minimum-value filtering unit 420 or a signal output from the differential-lower-value filtering unit 430.

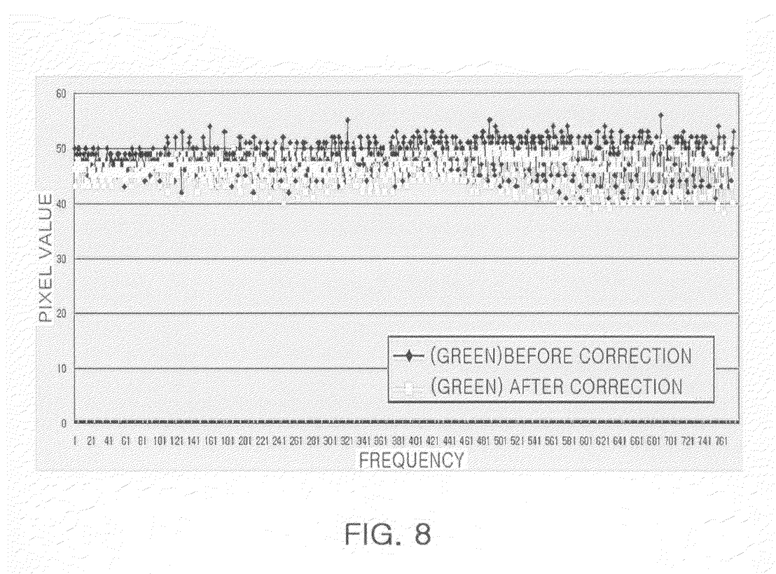

FIG. 8 is a graph for showing pixel values of an image before and after correction according to the present invention. In FIG. 8, the vertical axis indicates a pixel value, and the horizontal axis indicates a frequency.

Operations and effects of embodiments of the present invention will now be described in more detailed with reference to accompanying drawings.

Referring to FIGS. 3 through 7, removing noise in a dark area of an image will be described.

Referring to FIG. 3, in operation S100, an edge magnitude of an N×N window image including a plurality of pixels is calculated. The N×N window image may correspond to a 5×5 window image, and this will now be described with reference to FIGS. 4A and 4B.

FIGS. 4A and 4B illustrate 5×5 window image patterns, respectively. In FIG. 4A, a green pixel G is placed at the center of the 5×5 window image pattern, while in FIG. B, a blue pixel B is placed at the center of the 5×5 window image pattern.

For example, an edge detection process will now be described with reference to FIGS. 4A and 4B.

If there is a vertical or horizontal edge in the 5×5 window image, it is determined that an edge area is present in the window image. However, if there is no vertical or horizontal edge in the 5×5 window image, it is determined that no edge area is present in the window image.

As illustrated in FIG. 4A, a green pixel (hereinafter referred to as G) is placed at the center of the 5×5 window image. The G placed at the center thereof indicates that a pixel to be improved is the G, a so-called green channel. Values associated with an edge area are calculated by using neighboring-green-channel components through equations 1 through 4 below.

Horizontal magnitude=|G11−G13|+|G13−G15|+|G22−G24|+|G31−G35|+G42−G44|+G51−G53|+G53−G55| Equation 1

Vertical magnitude=G11−G31+G31−G51|+|G22−G42|+G13−G53|+|G24−G44|+G15−G35|+G35−G55| Equation 2

Horizontal mean=horizontal magnitude/7 Equation 3

Vertical mean=vertical magnitude/7 Equation 4

By using equations 1 through 4, it can be determined whether an edge area with respect to the G components exists, and the edge magnitudes and the mean values can be obtained.

As illustrated in FIG. 4B, a blue pixel (hereinafter, referred to as B) is placed at the center of the 5×5 window image. The B placed at the center indicates that a pixel to be improved is the B, a so-called blue channel. Values associated with an edge area are calculated using neighboring-blue-channel components by equations 5 through 8 below.

Horizontal magnitude=|B11−B13+B13−B15+|B31−B35+B51−B53+|B53−B55| Equation 5

Vertical magnitude=B11−B31|+|B31−B51|+|B13−B53|+B15−B35|+|B35−B55| Equation 6

Horizontal mean=horizontal magnitude/5 Equation 7

Vertical mean=vertical magnitude/5 Equation 8

By using equations 5 through 8 above, it can be determined whether an edge area with respect to the B components exists, and the edge magnitudes and the mean values can be obtained.

Thereafter, in operation S200, it is determined whether an edge area exists in the window image on the basis of the edge magnitudes.

For example, equation 1 calculates a difference value between pixel values for horizontal components, and when an edge area is present in a vertical direction, the difference value is higher than an edge reference value. Also, equation 2 calculates a difference value between pixel values for vertical components, and when an edge is present in a horizontal direction, the difference value is higher than an edge reference value.

The edge reference value is a threshold value that can be determined externally, and serves as a reference for determining presence of the edge area. A vertical edge and a horizontal edge may be detected by equations 9 and 10 below.

If (horizontal mean>Vth_{edge}) Equation 9

If (vertical mean>Vth_{edge}) Equation 10

where Vth_{edge} denotes the edge reference value.

When the condition of equation 9 is satisfied, it can be determined that the 5×5 window image includes a vertical edge area. Also, when the condition of equation 10 is satisfied, it can be determined that the 5×5 window image includes a horizontal edge area.

In operation S300, when no edge area is present in operation S200, a mean value of brightness of the window image is calculated.

For example, when a condition of equation 11 below with reference to equations 9 and 10 is satisfied, it can be determined that no edge area is present in the window image.

If ((horizontal mean<Vth_{edge}) and (vertical mean<Vth_{edge})) Equation 11

When it is determined that an edge area does not exist in the 5×5 window image using equation 11, brightness of the window image is determined as follows to detect a bright area or a dark area in the window image.

In operation S400, a bright area or a dark area is detected in the 5×5 window image on the basis of a mean value of brightness.

For example, to detect a dark area, the magnitude and the mean value of G components of the image illustrated in FIG. 4A may be calculated by equation 12 below, and the magnitude and the mean value of B components of the image of FIG. 4B may be calculated by equation 13 below.

G_SUM=G11+G13+G15+G22+G24+G31+G35+G42+G44+G51+G53+G55G_MEAN=G_SUM/12 Equation 12

B_SUM=B11+B13+B15+B31+B35+B51+B53+B55B_MEAN=B_SUM/8 Equation 13

The dark area can be easily detected by calculating the mean value of the G components in the 5×5 window image using equation 12. Also, the dark area can be easily detected by calculating the mean value of the B components in the 5×5 window image using equation 13.

The dark area of the image of FIG. 4A is detected by equation 14, and the dark area of the image of FIG. 4B is detected by equation 15.

If (G^{MEAN}<Vth_{dark}) Equation 14

If (B_{MEAN}<Vth_{dark}) Equation 15

In equations 14 and 15, Vth_{dark} denotes a brightness reference value for detecting the dark area.

When the conditions of equations 14 and 15 are met, as illustrated in FIG. 5, the window image can be finally determined as a sufficiently dark area in which noise can be removed.

In a sensor output in Bayer format, an arrangement of the B channels is the same as that of R channels. For this reason, the aforementioned detection method can be applied for an area associated with R components.

Referring to FIG. 5, a non-edge area and an edge area may be detected in a window image. In FIG. 5, a white area is a dark area, a black area is a bright area, and a boundary between the white and black areas is an edge area. Here, the black area is a portion where an image value is higher than a reference value, and no process is performed on this area. The white area is a portion where an image value is lower than the reference value, and noise removal is performed on this area.

In operation S500, when the mean value of brightness is higher the preset brightness reference value, it is determined that the window image corresponds to a bright area, and low-pass filtering is performed on the window image.

In operation S600, whenthe mean value of the brightness does not exceed the brightness reference value, the window image is determined as a dark area, and minimum filtering is performed on the window image.

Herein, in operation S600, each pixel value of the window image can be substituted with a substitution value determined differently depending on a darkness degree based on the mean value of brightness of the dark area in the window image, and this will now be described with reference to FIG. 6.

Referring to FIG. 6, in operation S600, the mean value of brightness of the dark area in the window image is compared with a first preset black reference value. Thereafter, when the mean value of brightness is lower than the first preset black reference value, the minimum pixel value of the window image is obtained, and each pixel value of the window image is substituted with the minimum pixel value.

In detail, an important characteristic of a dark area of an image is that a minimum pixel value, not median pixel values, can represent the dark area. Thus, much random noise of chroma components appears in the dark area of the image in the case of indoor or night photographing during which an exposure time of lengths, and the noise occurs in the form of dots.

Referring to FIGS. 4A and 4B, when the G is selected in the 5×5 window image in the Bayer format, information of 13 identical neighboring channels may be provided. Also, when the R or B is selected, information of 9 identical neighboring channels may be provided.

Here, the random noise occurring in a current pixel can be corrected by selecting a minimum pixel value of the neighboring identical channels within the 5×5 window image and substituting a current pixel value with the minimum pixel value. The substitution of the minimum pixel value can be made because the window image corresponds to the dark area.

The substitution of the minimum pixel value can contribute not only to removing noise but also increasing a contrast ratio of the image. Also, this substitution method is applicable to a portion of a primary color such as red, blue and green, so that an irrelevant chroma channel component appearing in a primary-color area can be removed, and the primary color can be expressed more clearly.

When the mean value of brightness is not lower than the first preset black reference value, a differential substitution value that is higher than the first black reference value by a preset value is obtained, and each pixel value of the window image is substituted with the differential substitution value.

The differential substitution value may be a mean value of a first minimum pixel value which is the smallest among a plurality of pixel values of the window image, and a second minimum pixel value which is the second smallest among the plurality of pixel values.

For example, when a pixel of the obtained minimum pixel value is a dead pixel called a cold pixel, a slight error may occur. In case of the dead pixel, the mean value of the first minimum pixel value and the second minimum pixel value can be used.

To determine the two minimum pixel values, pixel values within the 5×5 window image are sorted by magnitude.

The method for removing noise in a dark area of an image according to an embodiment of the present invention may be performed before image interpolation during a processing process of the window image.

Alternatively, the method for removing noise in a dark area of an image according to an embodiment of the present invention may be performed after the image interpolation during the processing process of the window image.

An apparatus for removing noise in a dark area of an image according to an embodiment of the present invention will now be described.

Referring to FIG. 7, the edge determining unit 100 of the apparatus for removing a dark area of an image determines whether an edge area is present in an N×N window image including a plurality of pixels, and outputs edge information to the multiplexer 600.

The brightness determining unit 200 calculates a mean value of brightness of the window image, determines whether the window image corresponds to a bright area or a dark area on the basis of the mean value of brightness, and outputs image brightness information to the multiplexer 600.

The first image delay unit 300 delays the window image by a preset time and outputs the delayed window image to the noise filtering unit 400. Here, a delay time of the first image delay unit 300 corresponds to a signal delay time for signal processing of the edge determining unit 100 and the brightness determining unit 200.

The noise filtering unit 400 performs low-pass filtering or minimum filtering on the window image output from the first image delay unit 300, and outputs a minimum-filtered signal to the multiplexer 600.

The second image delay unit 500 delays the window image output from the first image delay unit 300 by a preset time, and outputs the delayed window image to the multiplexer 600.

The multiplexer 600 selects one of a signal output from the noise filtering unit 400 and a signal output from the second image delay unit 500 on the basis of the edge information output from the edge determining unit 100. Also, the multiplexer 600 selects one of a low-pass filtered signal or a minimum-filtered signal among signals output from the noise filtering unit 400 on the basis of the image brightness information output from the brightness determining unit 200.

For example, the noise filtering unit 400 may include the low-pass filtering unit 410, the minimum-value filtering unit 420, and the differential-lower-value filtering unit 430. The low-pass filtering unit 410 performs low-pass filtering on the window image output from the first image delay unit 300, and outputs a low-pass filtered signal to the multiplexer 600.

The minimum-value filtering unit 410 performs minimum-value pass filtering on the window image output from the first image delay unit 300 and outputs a minimum-value pass filtered signal to the multiplexer.

The differential-lower-value filtering unit 430 performs differential-lower-value pass filtering on the window image output from the first image delay unit 300, and outputs a differential-lower-value pas filtered signal to the multiplexer 600.

The multiplexer 600 selects a signal output from the second image delay unit when the edge area is present in the window image on the basis of the edge information output from the edge determining unit 100. When no edge area is present in the window image and the image brightness information output from the brightness determining unit 200 indicates a bright area, the multiplexer 600 selects a signal output from the low-pass filtering unit 410. When no edge area is present in the window image and the image brightness information output from the brightness determining unit 200 indicates a dark area, the multiplexer selects a signal output from the minimum-value filtering unit 420 or a signal output from the differential-lower-value filtering unit 430 on the basis of the darkness information.

It can be seen from FIG. 8 that noise in the dark area can be reduced and the color saturation of primary colors can be improved when noise is removed from the dark area of the 5×5 window image according to each embodiment of the present invention.

FIG. 8 is a histogram of a corrected image according to the present invention. In FIG. 8, original data in a dark area are represented by black, and it can be seen that many of the original data have pixel values of 50 or higher. Those values result in noise at the time of subsequent image interpolation or by matrix multiplication equations of a color matrix.

In contrast, as for data (white portions) after correction according to the present invention, it can be seen that a contrast ratio of an entire image is improved because the noise occurring before correction is removed, and the original pixel values are substituted with smaller values.

According to the present invention, noise in a dark area of an image can be removed.

According to the present invention, data of Bayer format prior to the image interpolation is used instead of RGB or YCbCR data after image interpolation, so that influence of the image interpolation on noise can be minimized.

According to the present invention, a minimum filter that substitutes a pixel value with a minimum pixel value is used in a dark area instead of a low pass filter such as a mean filter or a median filter. Thus, the dark area becomes darker so that a contrast ratio can be improved, and influence of irrelevant pixel values in a primary color channel can be minimized, thereby improving color saturation.

As described so far, in the method for removing noise in a dark area of an image for a digital camera device according to the present invention, noise is removed from a dark area of an image, so that a contrast ratio of the image can be improved, and color saturation of the image can also be improved.

Removing noise before image interpolation can contribute to reducing propagation of noise to neighboring pixels at the time of the image interpolation.

Since noise is selectively removed in a dark area having no edge area, the minimum-value filtering unit, not a mean filter can be used, and noise can be effectively removed in the dark area within a specific 5×5 window image. Since a pixel value is substituted with a minimum pixel value, the dark area becomes darker so that the entire contrast ratio of the image can be improved.

Also, color saturation within respect to primary colors (e.g., blue, red and green) can be improved, so that the primary colors can be expressed more clearly.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for removing noise in a dark area of an image, the method comprising:
calculating an edge magnitude in an N×N window image including a plurality of pixels;
determining whether an edge area is present in the window image on the basis of the edge magnitude;
calculating a mean value of brightness of the window image when the edge area is not present;
determining whether the window image corresponds to a bright area or a dark area on the basis of the mean value of brightness;
determining the window image as the bright area when the mean value of brightness is higher than a preset brightness reference value, and performing low-pass filtering on the window image; and
determining the window image as the dark area when the mean value of brightness does not exceed the brightness reference value, and performing minimum filtering on the window image.

2. The method of claim 1, wherein the performing of the minimum filtering comprises substituting each pixel value of the window image with a substitution value determined differently depending on a darkness degree based on the mean value of brightness of the dark area of the window image.

3. The method of claim 1, wherein the performing of the minimum filtering comprises:
comparing the mean value of brightness of the dark area of the window image with a first preset black reference value;
calculating a minimum pixel value of the window image when the mean value of brightness is lower than the first preset black reference value, and substituting each pixel value of the window image with the minimum pixel value; and
calculating a differential substitution value that is higher than the first preset black reference value by a preset value when the mean value of brightness is not lower than the first black reference value, and substituting each pixel value of the window image with the differential substitution value.

4. The method of claim 3, wherein the differential substitution value is a mean value of a first minimum pixel value that is the lowest among a plurality of pixel values of the window image and a second minimum pixel value that is the second lowest among the plurality of pixel values of the window image.

5. The method of claim 1, wherein the minimum filtering is performed before image interpolation during a processing process of the window image.

6. The method of claim 1, wherein the minimum filtering is performed after image interpolation during a processing process of the window image.

7. The method of claim 1, wherein the N×N window image is a 5×5 window image.

8. An apparatus for removing noise in a dark area of an image comprising:
an edge determining unit determining whether an edge area is present in an N×N window image including a plurality of pixels;
a brightness determining unit calculating a mean value of brightness of the window image, and determining whether the window image corresponds to a bright area or a dark area on the basis of the mean value of brightness;
a first image delay unit delaying the window image by a preset time;
a noise filtering unit performing low-pass filtering and minimum filtering on the window image output from the first image delay unit;
a second image delay unit delaying the window image output from the first image delay unit by a preset time; and
a multiplexer selecting one of a signal output from the noise filtering unit and a signal output from the second image delay unit on the basis of edge information output from the edge determining unit, and selecting one of a low-pass filtered signal and a minimum-filtered signal among signals output from the noise filtering unit on the basis of image brightness information output from the brightness determining unit.

9. The apparatus of claim 8, wherein the noise filtering unit comprises:
a low-pass filtering unit performing low-pass filtering on the window image output from the first image delay unit;
a minimum-value filtering unit performing minimum-value pass filtering on the window image output from the first image delay unit; and
a differential-lower-value filtering unit performing differential-lower-value pass filtering on the window image output from the first image delay unit.

10. The apparatus of claim 9, wherein when the edge area is present in the window image on the basis of the edge information output from the edge determining unit, the multiplexer selects a signal output from the second image delay unit, and
when the edge area is not present in the window image, the multiplexer selects a signal output from the low-pass filtering unit if the image brightness information of the brightness determining unit indicates the bright area, and the multiplexer selects a signal output from the minimum-value filtering unit or a signal output from the differential-lower-value filtering unit on the basis of darkness information if the image brightness information output from the brightness determining unit indicates the dark area.
